(19) United States
(12) Patent Application Publication
(10) Pub. No.: US 2006/0049375 A1
(43) Pub. Date: Mar. 9, 2006

(54) Boronized valve seal

(75) Inventor: James L. Gossett, State Center, IA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FISHER CONTROLS INTERNATIONAL LLC, St. Louis, MO (US)

(21) Appl. No.: 11/030,782

(22) Filed: Jan. 7, 2005

Related U.S. Application Data
(63) Continuation-in-part of application No. 10/935,067, filed on Sep. 7, 2004.

(51) Int. Cl. F16K 1/48

(52) U.S. Cl. 251/357

(57) ABSTRACT

A control valve includes a first component, a second component, and a seal disposed there between. The first component defines a first surface that comprises a steel material, and the second component defines a second surface that comprises a steel material. The seal is disposed between the first and the second surfaces and comprises a boronized graphite material.

### RELATED APPLICATION DATA

The present application is a continuation-in-part application based on, and claiming the priority benefit of, co-pending U.S. application Ser. No. 10/935,067, which was filed on Sep. 7, 2004, and is expressly incorporated by reference herein.

### FIELD OF THE INVENTION

The present disclosure generally relates to seals for valves and, more particularly, relates to a boronized graphite seal for use between valve components.

### BACKGROUND OF THE DISCLOSURE

Control valves for controlling the flow of high pressure fluids and/or gases in a process system are generally well known in the art. In many applications, such control valves include a generally cylindrical valve plug that is movably disposed within a cage. The cage is mounted within the valve body so as to be disposed in the flow path between the inlet of the valve and the outlet of the valve. The cage typically includes, for example, a plurality of perforations. The valve plug may be positioned in a first position in which the valve plug blocks the perforations in the valve cage such that flow of process fluid through the valve is prevented. The valve may be shifted using, for example, a valve actuator, such that the valve plug is moved within the cage to a position in which at least some of the perforations are uncovered, such that flow of process fluid through the valve is permitted.

As is known, a control valve is typically provided with one or more seals to prevent leakage. For example, a seal is typically provided between the valve plug and the valve cage. Additionally, a seal is typically provided between the valve cage and the body of the valve. Due to the continuous frictional contact between the seals and other valve components and, other environment considerations such as heat and vibrations, the seals become worn or damaged which may result in sealing issues.

Accordingly, novel features in the construction of the seals and their associated components may be desired.

### BRIEF DESCRIPTION OF THE DRAWINGS

FIG. 1 is a cross-sectional view of a closed valve having boronized graphite seals in accordance with one example of the teachings of the present disclosure;

FIG. 2 is a cross-sectional view along line 2-2 of the valve of FIG. 1;

FIG. 3 is an isometric view of a boronized graphite seal of FIG. 1;

FIG. 4 is a detailed cross-sectional view of the boronized graphite seal valve of FIG. 1;

FIG. 5 is a cross-sectional view of a fully open valve of FIG. 1; and

FIG. 6 is a detailed cross-sectional view of the boronized graphite seal valve of FIG. 1.

### DETAILED DESCRIPTION

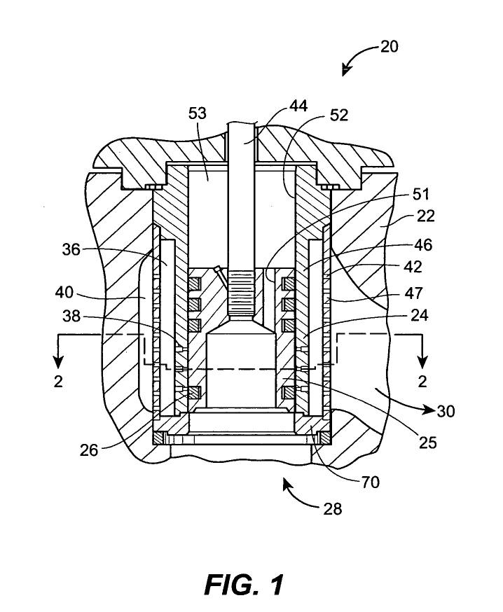

Referring to the drawings and with specific reference to FIG. 1, a valve having a boronized graphite seal as constructed in accordance with the teachings of the disclosure is generally depicted by reference numeral 20. As shown therein, the valve 20 in one exemplary embodiment includes a valve body 22, a valve cage 24, a valve plug 25, at least one boronized graphite seal 26, an inlet passage 28, an outlet passage 30, and a pathway 32 (FIG. 5) connecting the inlet passage 28 to the outlet passage 30.

As seen and oriented in FIG. 1, the inlet passage 28 of the valve 20 is disposed near a bottom of the valve body 22, and the outlet passage 30 is disposed to a side of the valve body 22. The valve 20 may be used to regulate the flow of a variety of fluids from the inlet passage 28 to the outlet passage 30 including, but not limited to, steam, hot air, gasses, liquids, or a combination thereof.

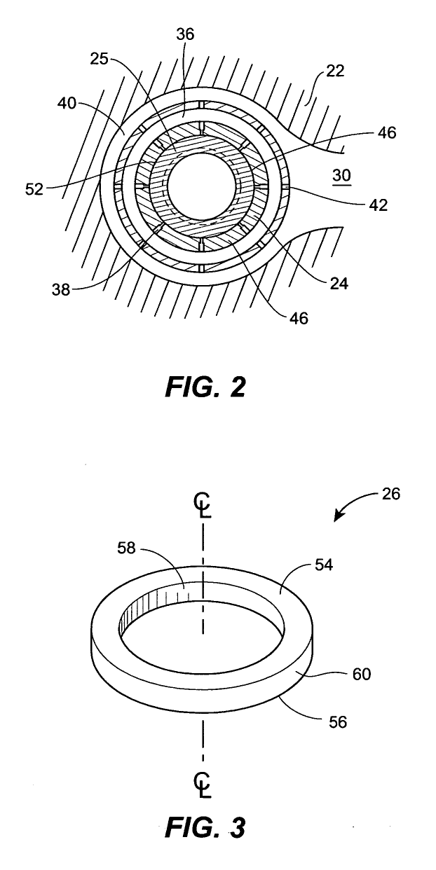

The valve body 22, valve cage 24, and valve plug 25 may be constructed from a metal material, such as low alloy and carbon steel, and may be coated with a nitriding process. The valve body 22 is formed with a bore sized to receive the cage 24. The valve cage 24, as illustrated in FIGS. 1 and 2, includes a first or inner set of apertures 38, and a second or outer set of apertures 42, with a center chamber 36 fluidly communicating between the first and second set of apertures 38, 42. Alternatively, the cage 24 may have a simple set of apertures with no center chamber. The valve housing 22 also defines an outer chamber 40 in fluid communication with the outlet passage 30 for receiving fluid exiting the outer set of apertures 42. The first set of apertures 38 are disposed near the bottom of an inner wall 46 of the cage 24, while the second set of apertures 42 are formed in an outer wall 47 of the cage 24. The inner wall 46 defines an inner surface 52 sized to receive the plug 25.

As illustrated in FIG. 1, the valve plug 25 is connected to the valve stem 44, and includes a cavity 50, a balancing passage 51, and the at least one boronized graphite seal 26. The valve stem 44, as illustrated in FIG. 1, is threadingly engaged with and at a top of the valve plug 25. The cavity 50 is formed in a bottom of the valve plug 25 and communicates with the balancing passage 51. The balancing passage 51 further communicates with an upper chamber 53 defined by the inner wall 46 of the cage 24 located above the plug 25. Because the plug 25 is balanced, there are at least two primary leak paths: a first path from the inlet passage 28 to the outlet passage 30 between the lower ends of the cage 24 and plug 25, and a second path from the inlet passage 28, through the cavity 50, the balancing passage 51 and the upper chamber 53 to the outlet passage 30 between the upper ends of the cage 24 and plug 25.

The at least one boronized graphite seal 26 is disposed and in this exemplary embodiment the boronized graphite seals 26, as seen in FIG. 1, are disposed around a periphery of the valve plug 25 and slidingly engage an interior surface 52 of the side wall 46 to prevent leakage through the primary leak paths. The boronized graphite seal 26, as seen in FIG. 3, has a generally ring-like shape with a generally square cross-sectional area. The boronized graphite seal 26 includes an upper surface 54, a lower surface 56, an inner surface 58, and an outer surface 60. The upper and lower surfaces 54, 56 are oriented generally parallel to each other and generally perpendicular to a center axis of the boronized graphite seal 26. The inner and outer surfaces 58, 60 are oriented generally parallel to each other and generally perpendicular to the upper and lower surfaces 54, 56 and parallel to the center axis of the boronized graphite seal 26. The boronized graphite seals 26 may have several desirable properties or qualities that make the seals 26 suitable for application in valves. For example, the boronized graphite seals 26 exhibit good wear resistance. As a result, the boronized graphite seals 26 produce very low wear rates with other mating materials and the mating surfaces of the boronized graphite seals 26 and other mating components wear in to produce tightly mating surfaces which reduces leakage. The boronized graphite is also unaffected at temperatures in the application range, has very low deterioration rates, and exhibits a low coefficient of friction.

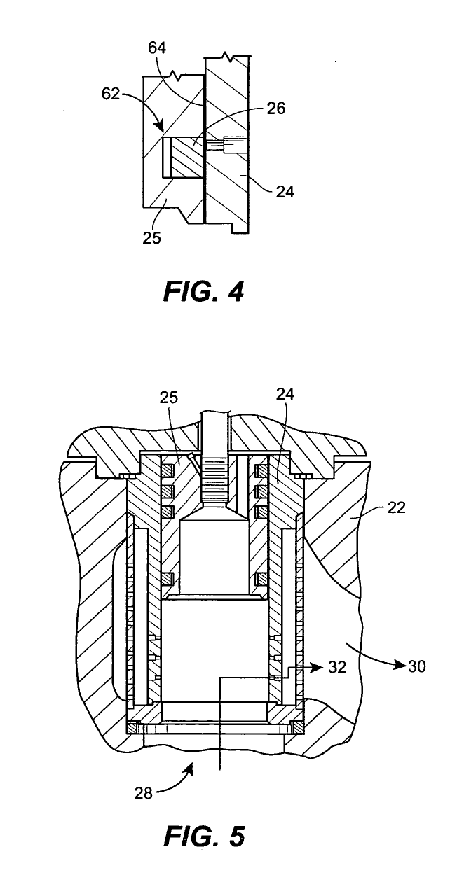

The boronized graphite seals 26, as seen in FIG. 4, are each disposed in a groove 62 that is disposed around a periphery of the valve plug 25. More specifically, the grooves 62 interrupt an outer surface 64 of the valve plug 25, and are sized and shaped to securely receive the boronized graphite seals 26.

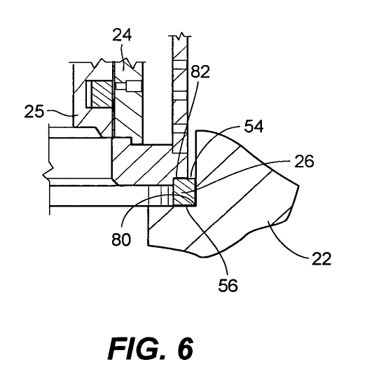

In an alternate or additional embodiment, as illustrated in FIG. 6, the valve 20 may include a boronized graphite seal 26 disposed between seat ring 70 and the body 22. The boronized graphite seal 26, in this exemplary embodiment, may be disposed between a seal surface 80 of valve body 22 and a seal surface 82 of seat ring 70, and more specifically, the upper surface 54 of the seal 26 may contact the seal surface 82 of the seat ring 70, and the lower surface 56 of the seal 26 may contact the seal surface 80 of the valve body 22. As such, the seal 26 may prevent flow of fluid through a potential third leak path disposed between the valve cage 24 and the valve body 22.

The seal 26, even though not directly in contact with the valve plug 25, may undergo sliding engagement with the valve body 22 and the valve cage 24. For example, during an operation in which the fluid traveling through the valve 20 is steam or other heated medium, the valve 20 may undergo thermal expansion. As a result, the various components of the valve 20, such as the valve body 22 and the valve cage 24 for example, may expand/contract at various rates, thereby causing movement of the valve components relative to each other. The valve components may expand/contract at various rates due to variations is material, component density, thickness, or other variations.

The above exemplary embodiments may include many variations thereof to achieve and/or create additional or alternative features. For example, the valve 20 need not be a valve as described herein, but could be any type of valve that requires or uses a seal. For example, the valve 20 may have an unbalanced plug and may have only a single primary leak path, in which case only one boronized 26 may be needed, In addition, the shape and size of the boronized graphite seals 26 as described herein may also vary. For example, the boronized graphite seals 26 may have an overall different shape, such as square, oval, rectangular, triangular, or a combination thereof. Similarly, the cross-section of the boronized graphite seals 26 may be oval, rectangular, triangular, or a combination thereof. In addition, the boronized graphite seal 26 may be disposed between other components of the valve 20, and may be disposed between a valve seat and the body 22 and/or the valve cage 24.

In operation, the valve 20 may move between a fully closed position, as seen in FIG. 1, to a fully open position, as seen in FIG. 5. In the fully closed position (FIG. 1), the valve plug 25 engages a valve seat 70 to prevent fluid from the inlet passage 30 from flowing through the cage 24 to the outlet passage 30. As the valve 20 moves from a closed position (FIG. 1) to an open position (FIG. 5), the outer surfaces 60 of the seals 26 will slidingly engage the interior surface 52 of the side wall 46 of the valve body 22. Additionally, during the movement of the valve plug 25, one or more of the seals 26 may slidingly engage at least a portion of the first plurality of apertures 38. As a result, during the movement of the valve gage 24 relative to the valve body 22, the seals 26 are subjected to frictional engagement with other valve components causing wear to the seals 26.

While the present disclosure describes specific embodiments, which are intended to be illustrative only and not to be limiting of the invention, it will be apparent to those of ordinary skill in the art that changes, additions or deletions may be made to the disclosed embodiments without departing from the spirit and scope of the disclosure.

What is claimed is:

1. A control valve comprising:
a first component defining a first surface, the first surface component comprising a steel material;
a second component defining a second surface, the second surface component comprising a steel material; and
a seal disposed between the first and the second surfaces, the seal comprising a boronized graphite material.

2. The control valve of claim 1, wherein the seal is carried by the first component and slidingly engages the second surface to restrict fluid flow between the first and second surfaces.

3. The control valve of claim 1, wherein the first component is a valve plug.

4. The control valve of claim 1, wherein the first component is a valve body.

5. The control valve of claim 1, wherein the second component is one of a seat ring and a cage.

6. The control valve of claim 1, wherein the first and the second components are constructed from carbon steel.

7. The control valve of claim 1, wherein the first and the second components are constructed from a low alloy steel.

8. The control valve of claim 1, wherein at least one of the first and the second components includes a coating comprising a nitride material.

9. A seal for a control valve comprising:
a generally cylindrical body constructed from a boronized graphite material, the body including,
an upper surface and a lower surface oriented generally parallel to each other,
cylindrical inner and cylindrical outer surfaces substantially concentric to each other and generally perpendicular to the upper and the lower surfaces,
wherein the outer surface engages a first component and the inner surface slidingly engages a second component.

10. The seal of claim 9, wherein the first component is a valve cage.

11. The seal of claim 9, wherein the second component is one of a seat ring and a plug.

12. The seal of claim 9, wherein the first and the second components are constructed from carbon steel.

13. The seal of claim 9, wherein the first and the second components are constructed from a low alloy steel.

14. The seal of claim 9, wherein at least one of the first and the second components includes a coating comprising a nitride material.

15. The seal of claim 9, wherein the upper surface engages the second component.

16. A seal for a control valve comprising:
a generally cylindrical body constructed from a boronized graphite material, the body including,
an upper surface and a lower surface oriented generally parallel to each other,
cylindrical inner and cylindrical outer surfaces substantially concentric to each other and generally perpendicular to the upper and the lower surfaces,
wherein the upper surface engages a first component and the lower surface engages a second component.

17. The seal of claim 16, wherein the first component is a valve body.

18. The seal of claim 16, wherein the second component is one of a seat ring and a plug.

19. A method of sealing a valve comprising:
providing a valve cage constructed from metal having an inlet, an outlet, and a pathway therebetween;
providing a plug disposed in the valve cage, for opening and closing the pathway; and
inserting at least one boronized graphite seal between the valve cage and the valve plug.

20. The method of sealing a valve of claim 19, further including coating at least one of the valve plug and the valve cage with a nitride material.

21. The method of sealing a valve of claim 19, further including constructing at least one of the valve cage and valve plug from low alloy steel.

22. The method of sealing a valve of claim 19, further including constructing at least one of the valve cage and valve plug from carbon steel.

23. The method of sealing a valve of claim 19, wherein opening and closing the pathway includes slidingly engaging the at least one boronized graphite seal against and relative to the valve cage.

24. The method of sealing a valve of claim 19, further including inserting a boronized graphite seal between the valve cage and the valve body.
